(19) United States
(12) Patent Application Publication
(10) Pub. No.: US 2013/0120762 A1
(43) Pub. Date: May 16, 2013

(54) DIAPHRAGM POSITION MEASURING METHOD, DIAPHRAGM POSITION MEASURING APPARATUS, DIAPHRAGM POSITIONING METHOD AND DIAPHRAGM POSITIONING APPARATUS

(71) Applicant: Kazuhiro Wada, Hachioji-shi (JP)

(72) Inventor: Kazuhiro Wada, Hachioji-shi (JP)

(21) Appl. No.: 13/811,536

(22) PCT Filed: Jul. 12, 2011
(86) PCT No.: PCT/JP2011/065835

§ 371 Date: Jan. 22, 2013

(30) Foreign Application Priority Data
Jul. 23, 2010 (JP) 2010-165828

(51) Int. Cl. G01B 11/14

(52) U.S. Cl. CPC G01B 11/14
USPC 356/614

(57) ABSTRACT

A diaphragm position measuring method and a diaphragm position measuring apparatus are disclosed, which are capable of measuring a deviation quantity between a center of an optical diaphragm and an optical axis with high accuracy. A diaphragm positioning method and a diaphragm positioning apparatus are further disclosed, which are capable of disposing the optical diaphragm in a lens unit with the high accuracy. A light condensing spot is formed by getting a collimated beam of light incident upon lenses of the lens units supported on a glass sheet, and a position of the light condensing spot, if detected by a microscope, can be used as a reference point for positioning the optical diaphragm. A central processing unit can obtain a deviation quantity between the position of the light condensing spot and a central position of the optical diaphragm, which is acquired by the microscope, and the lens unit can be effectively inspected by use of a result thereof. It is thereby feasible to detect the deviation quantity of the central position of the optical diaphragm with an error equal to or smaller than ±3 μm.

### TECHNICAL FIELD

The present invention relates to a diaphragm position measuring method, a diaphragm position measuring apparatus, a diaphragm positioning method and a diaphragm positioning apparatus each suited to an imaging apparatus using a solid-state imaging device such as a COD (Charge Coupled Device) type image sensor or a CMOS (Complementary Metal Oxide Semiconductor) type image sensor.

### BACKGROUND ART

In the recent years, the spread of mobile phones and PDAs (Personal Digital Assistants) is underway, which are equipped with the imaging apparatus using the solid-state imaging device such as the CCD type image sensor or the CMOS type image sensor. Recently, the solid-state imaging devices used for these imaging apparatuses are increasingly downsized, in which with respect to VGA (Video Graphics Array) image formatted sensors (an effective pixel count is 640×480), the solid-state imaging devices having a size of 1/10 in. (a pixel pitch is 2.2 μm) and 1/12 in. (the pixel pitch is 1.75 μm) are commercialized. With this commercialization, further downsizing and decrease in cost are highly requested of imaging lenses mounted in the imaging apparatus.

By the way, a lens unit oriented to this type of imaging apparatus is fitted with an optical diaphragm for intercepting incidence of unnecessary beams of light. It has hitherto been conducted that a mirror frame is provided beforehand with a fitting portion designed so that an optical axis of the lenses becomes substantially coincident with the center of the optical diaphragm, and the lenses and the optical diaphragm are mounted in the mirror frame, thereby making the optical axis of the lenses substantially coincident, with the center of the optical diaphragm. Even such a conventional positioning method is capable of making the optical axis approximate to the center of the optical diaphragm with some degree of accuracy, and therefore, no particular problem occurs in the conventional imaging apparatus including the solid-state imaging device that is comparatively small in number of pixels.

With a much higher image quality of the solid-state imaging device, however, when more precise positioning is required, there cannot be ignored a deviation quantity between the central position of the optical diaphragm and the actual optical axis, which is derived from dimensional accuracy, fitting accuracy, etc of the components. Hence, there newly arise necessities for distinguishing what shows an excessively large deviation quantity therebetween and measuring a quantity of eccentricity between the optical axis of the lenses and the center of the optical diaphragm in order to be reflected in adjustment of manufacturing conditions.

### PRIOR ART DOCUMENT

### Patent Document

[Patent Document 1] Japanese Patent Application Laid-Open Publication No. 2005-5597

### DISCLOSURE OF THE INVENTION

### Problems to be Solved by the Invention

Patent document 1 discloses a lens measuring apparatus configured to obtain spectral characteristic data on a per diaphragm value basis by irradiating the diaphragm with the light. Patent document 1 describes, however, nothing about measuring the quantity of eccentricity between the optical axis of the lenses and the center of the optical diaphragm in terms of what has been described above or about a method of assembling (components) to obviate the deviation. Note that it is considered as an eccentricity quantity measuring method to measure the quantity of eccentricity from the center of the optical diaphragm that is actually measured by calculating an imaginary optical axis from, e.g., an outside diameter of the lens and an outside diameter of the mirror frame, however, such a problem exists that an error in the quantity of eccentricity between the true optical axis of the lenses and the center of the optical diaphragm becomes large (becomes equal to or larger than, e.g., ±20 μm) due to factors such as a deviation between the outside diameter of the lens and the optical axis, the accuracy of the outside diameter of the lens and the accuracy of the components of the mirror frame.

Under such circumstance, it is an object of the present invention to provide a diaphragm position measuring method and a diaphragm position measuring apparatus, which are capable of measuring a deviation quantity between a center of an optical diaphragm and an optical axis with high accuracy. It is another object of the present invention to provide a diaphragm positioning method and a diaphragm positioning apparatus, which are capable of disposing the optical diaphragm in a lens unit with the high accuracy.

### Means for Solving the Problems

A diaphragm position measuring method according to claim 1 is a method of measuring a position of an optical diaphragm in a lens unit including the optical diaphragm, lenses and a mirror frame holding the optical diaphragm and the lenses, the method including: a step of forming a light condensing spot by getting a collimated beam of light parallel with an optical axis of the lenses incident upon the lenses of the lens unit; a step of detecting a position of the light condensing spot; a step of detecting a central position of the optical diaphragm; and a step of obtaining a deviation quantity between the position of the light, condensing spot and the central position of the optical diaphragm.

The present inventors discovered that the position of the optical axis serving as the reference for positioning the optical diaphragm can be estimated with high accuracy by making use of a light condensing spot being formed in a predetermined position (e.g., an imaging surface of an imaging device used together with the lens unit) on the optical axis in the case of getting a collimated beam of light parallel with the optical axis incident upon the lenses. Namely, the light condensing spot is formed by making the collimated beam of light incident upon the lenses of the lens unit, and the position of the light condensing spot can be, if detected, used as a reference point for positioning the optical diaphragm. A deviation quantity between the position of the light condensing spot and a separately obtained central position of the optical diaphragm is thereby acquired, and the lens unit can be effectively inspected by use of a result thereof. According to the present invention, it is feasible to detect the deviation quantity of the central position of the optical diaphragm with an error equal to or smaller than ±3 μm.

The diaphragm position measuring method according to claim 2 is, in the diaphragm position measuring apparatus according to claim 1, characterized in that the step of detecting the central position of the optical diaphragm involves obtaining geometrically the central position of the optical, diaphragm from a shape of an inside diameter of the optical diaphragm. A shape of the optical diaphragm is generally circular, and hence the central position thereof can be comparatively easily obtained in terms of geometries with the high accuracy. For example, two perpendicular bisectors in line segments connecting arbitrary two points on the inside diameter (but excluding the diameter) are drawn in a way that intersects each other, and an intersection thereof becomes the center of the circle and may be therefore set as the central position of the optical diaphragm. The way of how the central position is obtained is not, however, limited to this method, and the method described in, e.g., Japanese Unexamined Patent Publication No, 2007-524805 may also be employed.

A diaphragm position measuring apparatus according to claim 3 is an apparatus of measuring a position of an optical diaphragm in a lens unit including the optical diaphragm, lenses and a mirror frame holding the optical diaphragm and the lenses, the apparatus including: a support base including at least a portion as a transmitted portion that can be penetrated by the light and supporting the lens unit in superposition on the transmitted portion; a light irradiation device irradiating the lens unit with the collimated beam of light parallel with the optical axis of the lenses of the lens unit; first detecting means detecting a position of the light condensing spot formed when the collimated beam of light penetrates the lenses of the lens unit; second detecting means detecting the central position of the optical diaphragm; and arithmetic means obtaining a deviation quantity between the detected position of the light condensing spot and the central position of the optical diaphragm.

The light condensing spot is formed by making the collimated beam of light incident upon the lenses of the lens unit supported on the support base, and the position of the light condensing spot can be, if detected by the first detecting means, used as the reference point for positioning the optical diaphragm. According to the present invention, the deviation quantity between the position of the light condensing spot and the central position of the optical diaphragm that is obtained by the second detecting means, can be acquired by the arithmetic means, and the lens unit can be effectively inspected by use of a result thereof. According to the present invention, it is possible to detect the deviation quantity of the central position of the optical diaphragm with the error equal to or smaller than ±3 μm.

The diaphragm position measuring apparatus according to claim 4 is, in the diaphragm position measuring apparatus according to claim 3, characterized by further including a Z-directional moving stage moving the first detecting means and/or the second detecting means and the support base relatively in a collimated beam emitting direction. It is thereby feasible to focus on the light condensing spot on which the light is condensed through the lenses.

The diaphragm position measuring apparatus according to claim 5 is, in the diaphragm position measuring apparatus according claim 3 or 4, characterized by further including: an XY-directional moving stage moving the first detecting means and/or the second detecting means and the support base relatively in a direction orthogonal to the collimated beam emitting direction; and moving guantity detecting means detecting a moving quantity of the XY-directional moving stage. The XY-directional moving stage moves the first detecting means or the second detecting means and the support base relatively in the direction orthogonal to the collimated beam emitting direction, thereby enabling a capture of the light condensing spot on which the light is condensed through the lenses, enabling a detection of the central position, of the optical diaphragm and enabling a detection of coordinates of the light condensing spot and coordinates of the central position of the optical diaphragm by the moving quantity detecting means detecting the moving quantity of the XY-directional moving stage on that occasion.

The diaphragm position measuring apparatus according to claim 6 is, in the diaphragm position measuring apparatus according to any one of claims 3 to 5, characterized by further including a tilt stage tilting the light irradiation device and the support base relatively in the collimated beam emitting direction. With this configuration, the collimated beam of light emitted from the light source can be made incident on the lenses along the optical axis thereof.

The diaphragm position measuring apparatus according to claim 7 is, in the diaphragm position measuring apparatus according to claim 6, characterized by further including tilt detecting means detecting a relative tilt of the support base to the collimated beam of light. The detection of this tilt enables the collimated beam of light emitted from the light source to enter the lenses along the optical axis of the lenses.

The diaphragm position measuring apparatus according to claim 8 is, in the diaphragm position measuring apparatus according any one of claims 3 to 7, characterized in that a light reduction member is inserted in between the first detecting means and the support base. With this arrangement, a light intensity can be reduced down to a utilization level via the light reduction member in the case of using the light exhibiting a high intensity such as a laser beam by way of the collimated beam of light.

The diaphragm position measuring apparatus according claim 9 is, in the diaphragm position measuring apparatus according to any one of claims 3 to 8, characterized in that the first detecting means serves also as the second detecting means. For example, a microscope can be employed in common as the first detecting means and the second detecting means.

An optical diaphragm positioning method according to claim 10 is a method of positioning an optical diaphragm with respect to a lens unit including lenses and a mirror frame holding the lenses, the method including: a step of forming a light condensing spot by getting a collimated beam of light parallel with an optical axis of the lenses incident upon the lenses of the lens unit; a step of holding the optical diaphragm in the lens unit in a way that temporarily positions the optical diaphragm; a step of detecting a central position of the optical diaphragm; a step of shifting the optical diaphragm so that the central position of the optical diaphragm is coincident with the position of the light condensing spot; and a step of fixing the optical diaphragm to the lens unit when the central position of the optical diaphragm becomes coincident with the position of the light condensing spot.

The light condensing spot is formed by getting the collimated beam of light parallel with the optical axis incident upon the optical axis of the lenses of the lens unit, and the position of the light condensing spot, if detected, can be used as the reference point for positioning the optical diaphragm. Such being the case, according to the present invention, the lens unit can be obtained, in which the optical diaphragm is shifted so that the central position of the temporarily positioned optical diaphragm becomes coincident with the position of the light condensing spot and is thereafter fixed, and the optical diaphragm is positioned with the high accuracy. According to the present invention, the optical diaphragm can be assembled with an error equal to or smaller than ±3 μm with respect to the optical axis.

The optical diaphragm positioning method according to claim 11 is, in the optical diaphragm positioning method according to claim 10, characterized in that the step of detecting the central position of the optical diaphragm involves obtaining geometrically the central position of the optical diaphragm from a shape of an inside diameter of the optical diaphragm.

An optical diaphragm positioning apparatus according to claim 12 is an apparatus for positioning an optical diaphragm with respect to a lens unit including lenses and a mirror, frame holding the lenses, the apparatus including: a support base including at least a portion composed of a material that can be penetrated by the light and supporting the lens unit; a holding member holding the optical diaphragm in the lens unit in a way that temporarily positions the optical diaphragm; a light irradiation device irradiating the lens unit with a collimated beam of light parallel with an optical, axis of the lenses of the lens unit; first detecting means detecting a position of the light condensing spot formed when the collimated beam of light penetrates the lenses of the lens unit; second detecting means detecting a central position of the optical diaphragm; and a driving device shifting the holding member together with the optical diaphragm so as to decrease a deviation quantity between the detected position of the light condensing spot and the central position of the optical diaphragm.

The light condensing spot is formed by getting the collimated beam of light parallel with the optical axis incident, upon the lenses of the lens unit supported on the support base, and the position of the light condensing spot, if detected by the first detecting means, can be used as the reference point for positioning the optical diaphragm. According to the present invention, the lens unit can be obtained, in which the optical diaphragm is shifted by the driving device so that the central, position, detected by the second detecting means, of the temporarily positioned optical diaphragm becomes approximate to the detected position of the light condensing spot, and the optical diaphragm can be positioned with the high precision by fixing the optical diaphragm after both of the positions have been coincident. According to the present invention, the optical diaphragm can be assembled with the error equal to or smaller than ±3 μm with respect to the optical axis.

The optical diaphragm positioning apparatus according to claim 13 is, in the optical diaphragm positioning apparatus according to claim 12, characterized by further including a Z-directional moving stage moving the first detecting means or the second detecting means and the support base relatively in a collimated beam emitting direction. With this configuration, it is possible to focus on the light condensing spot on which the light is condensed through the lenses.

The optical diaphragm positioning apparatus according to claim 14 is, in the optical diaphragm positioning apparatus according to claim 12 or 13, characterized by further including an XY-directional moving stage moving the first detecting means or the second detecting means and the support base relatively in a direction orthogonal, to the collimated beam emitting direction; and moving quantity detecting means detecting a moving quantity of the XY-directional moving stage. The XY-directional moving stage moves the first detecting means and the support base relatively in the direction orthogonal to the collimated beam emitting direction, thereby enabling the light condensing spot on which the light is condensed through the lenses to be captured and the central position of the optical diaphragm to be detected, on which occasion the moving quantity detecting means detects the moving quantity of the XY-directional moving stage with the result that the coordinates of the light condensing spot and of the central position of the optical diaphragm can be detected.

The optical diaphragm positioning apparatus according to claim 15 is, in the optical diaphragm positioning apparatus according to any one of claims 12 to 14, characterized by further including a tilt stage tilting the light source and the support base relatively in the collimated beam emitting direction. With this configuration, the collimated beam of light emitted from the light source can be made incident upon the lenses along the axis thereof.

The optical diaphragm positioning apparatus according to claim 16 is, in the optical diaphragm positioning apparatus according to claim 15, characterized by further including tilt detecting means detecting a relative tilt of the support base to the collimated beam of light. With the detection thereof, the collimated beam of light emitted from the light source can be made incident upon the lenses along the axis thereof.

The optical diaphragm positioning apparatus according to claim 17, in the optical diaphragm positioning apparatus according to any one of claims 12 to 16, characterized in that a light reduction member is inserted in between the first detecting means and the support base. With this arrangement, the light intensity can be reduced down to the utilization level via the light reduction member in the case of using the light exhibiting the high intensity such as the laser beam by way of the collimated beam of light.

The optical diaphragm positioning apparatus according to claim 18, in the optical diaphragm positioning apparatus according to any one of claims 12 to 17, characterized in that the first detecting means and the second detecting means are common to each other. For example, in the microscope, the first detecting means can serve also as the second detecting means.

### Effects of the Invention

According to the present invention, it is feasible to provide the diaphragm position measuring method and the diaphragm position measuring apparatus each capable of measuring the deviation quantity between the center of the optical diaphragm and the optical axis with the high accuracy, and it is also possible to provide the diaphragm positioning method and the diaphragm positioning apparatus each capable of disposing the optical diaphragm in the lens unit with the high precision.

### BRIEF DESCRIPTION OF THE DRAWINGS

FIG. 1 is a sectional view of a lens unit.

FIG. 2 is a schematic perspective view of a diaphragm position measuring apparatus according to an embodiment.

FIG. 3 is a sectional view of the lens unit undergoing a measurement made by the diaphragm position measuring apparatus.

FIG. 4 is a flowchart illustrating an operation of the diaphragm position measuring apparatus.

FIG. 5 is a view depicting an example of a light condensing spot.

FIG. 6 is a view illustrating an example of an image of the optical diaphragm, in which a diameter is indicated by an arrowed line.

FIG. 7 is a schematic perspective view of a diaphragm positioning apparatus according to the embodiment.

FIG. 8 is a sectional view illustrating, together with a jig, the lens unit in which the optical diaphragm is assembled by the diaphragm positioning apparatus.

FIG. 9 is a flowchart illustrating an operation of the diaphragm position measuring apparatus.

FIG. 10 is a sectional view of the lens unit according to a modified example.

### MODE FOR CARRYING OUT THE INVENTION

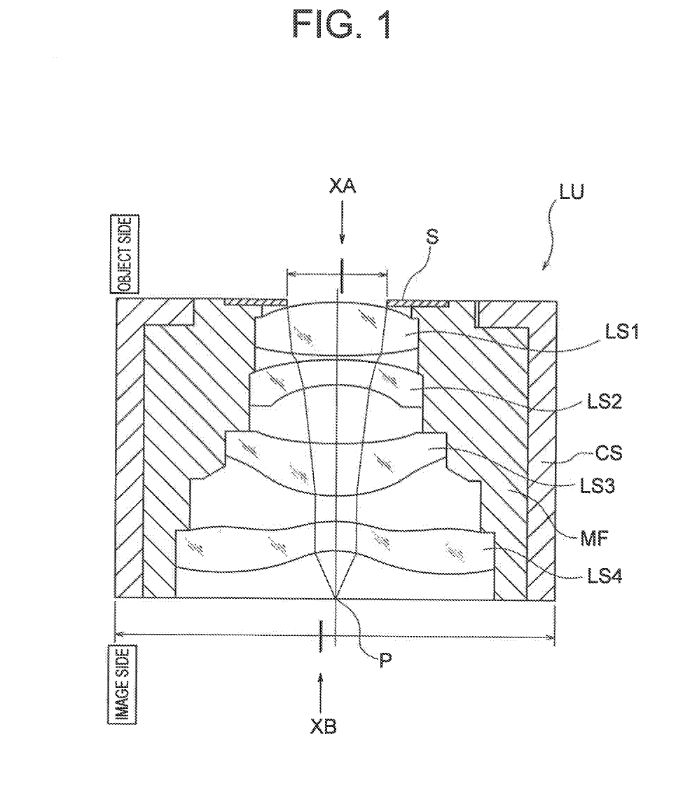

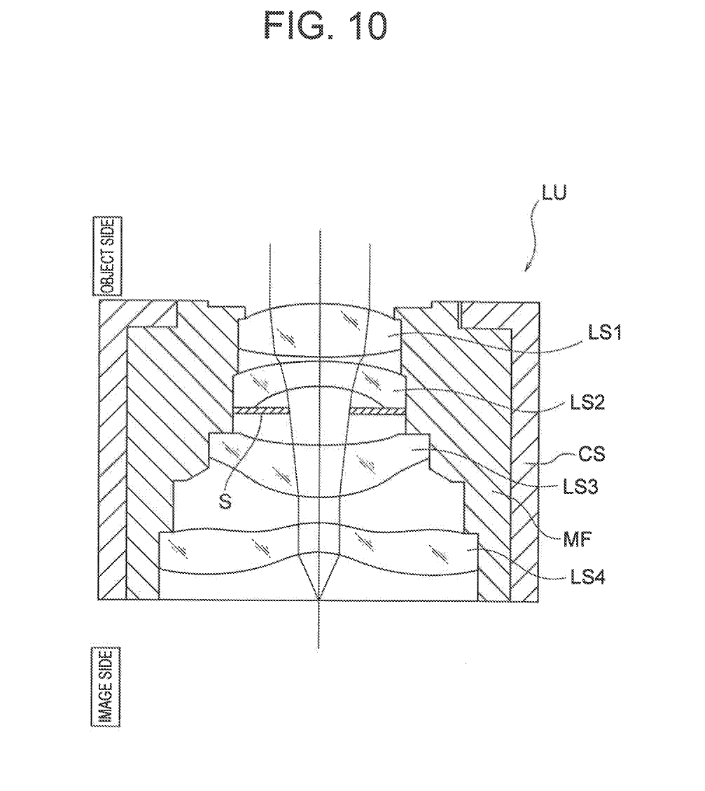

An embodiment of the present invention will hereinafter be described with reference to the drawings. FIG. 1 is a sectional view of a lens unit used in the present embodiment. In FIG. 1, a lens unit LU, which builds up an imaging apparatus by assembling an unillustrated solid-state imaging device to an image-side portion thereof, is configured to include sequentially from an object side an optical diaphragm (optical stop) S, a lens LS1, a lens LS2, a lens LS3 and a lens LS4 that are fixed within a mirror frame MF inserted into a case CS. The optical diaphragm S is constructed by using a plate member having a circular aperture at the center, and can be also, without being limited to a mode of existing outermost in an optical-axis direction as illustrated in FIG. 1, provided in a variety of positions such as an interior (between the lenses LS2 and LS3 in this modified example) as depicted in, e.g., FIG. 10. The case of the optical diaphragm S existing outermost facilitates positioning the optical diaphragm S, however, a case of the lens unit with the optical diaphragm S existing inside is also capable of inspecting a defective component by virtue of the embodiment that will hereinafter be discussed as in the case of the optical diaphragm S existing outermost. Herein, when a collimated beam of light parallel with an optical axis of the lens enters the lens unit LU from the object side, a light condensing spot is formed on a predetermined position P (which is herein a position corresponding to an imaging plane of the solid-state imaging device when assembling the solid-state imaging device). Incidentally, it is assumed that end surfaces of the case CS on the image side and the object side are highly accurately orthogonal to the optical axis of the lens. Further, what integrates the case and the mirror frame into one unit is also called the mirror frame as the case may be.

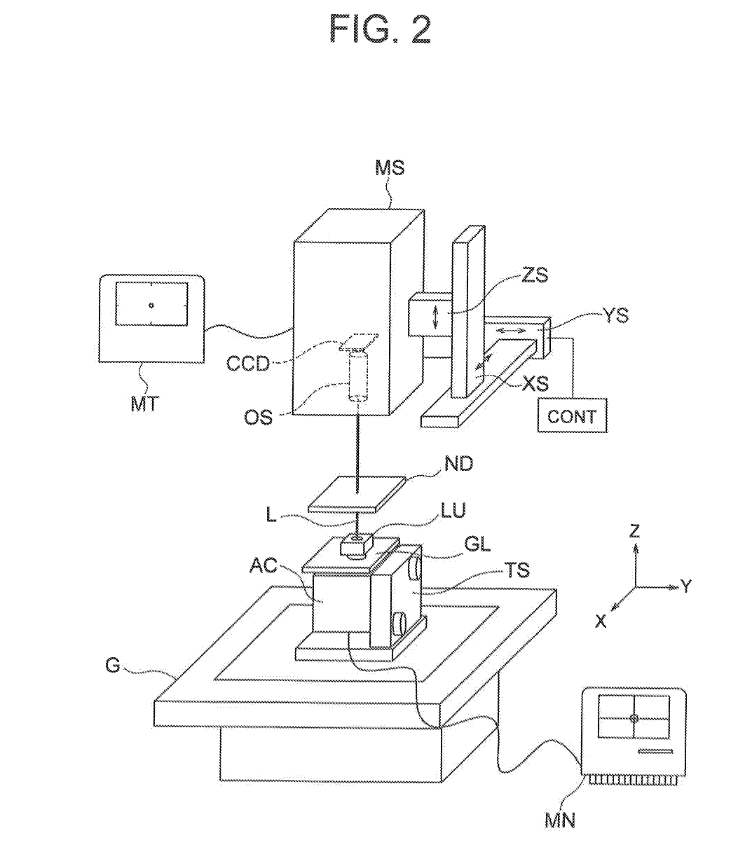

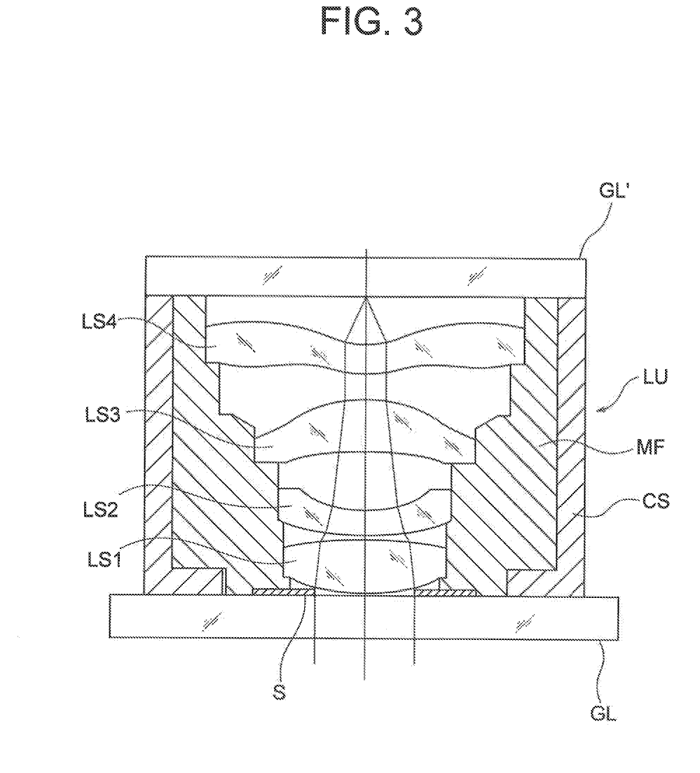

FIG. 2 is a schematic perspective view of a diaphragm position measuring apparatus according to the embodiment. In FIG. 2, a perpendicular direction is defined by a Z-direction, while a horizontal direction is defined by X- and Y-directions. An auto collimator AC and a tilt stage TS are installed on a surface plate G. The tilt stage TS is constructed to enable a held glass sheet GL to be tilted. The lens unit LU as an object undergoing the measurement (measurement target object) is placed on a transmitted portion of the glass sheet. CL that serves as a support base in the way of directing the object side thereof toward the auto collimator AC (see FIG. 3). Note that the auto collimator AC including a laser light source having visible light wavelengths configures a tilt detection means and is contrived to emit a laser beam L defined as a collimated beam in an upward direction, detect a reflected image therefrom and project the image on a monitor MN. An aperture (a stop for the measurement) is provided between the auto collimator AC and the glass sheet CL, thereby enabling unnecessary light beams to be cut and improving measurement accuracy as the case may be. A resin sheet may be used in place of the glass sheet GL.

An ND (Neutral Density) filter (light reduction filter) serving as a light reduction member is disposed above the lens unit LU, and a microscope MS is disposed above the ND filter. The ND filter ND may also be provided on the object side of the lens unit LU. The microscope MS is movable in the Z-direction by a Z-directional stage CS, movable in the X-direction by an X-directional stage XS and movable in the Y-direction by a Y-directional state YS. Note that the respective stages are provided with unillustrated drive sources and sensors (moving quantity detecting means) which detect moving quantities, i.e., a Z-directional moving quantity, a X-directional moving quantity and a Y-directional moving quantity, and these moving quantities are inputted to a central processing unit (CPU) CONT defined as an arithmetic means.

The microscope MS serving as a first detecting means and a second detecting means includes an optical system. OS and an imaging element. COD, in which the imaging element COD captures an image of the light penetrating the optical system OS, and the image is projected on a monitor MT.

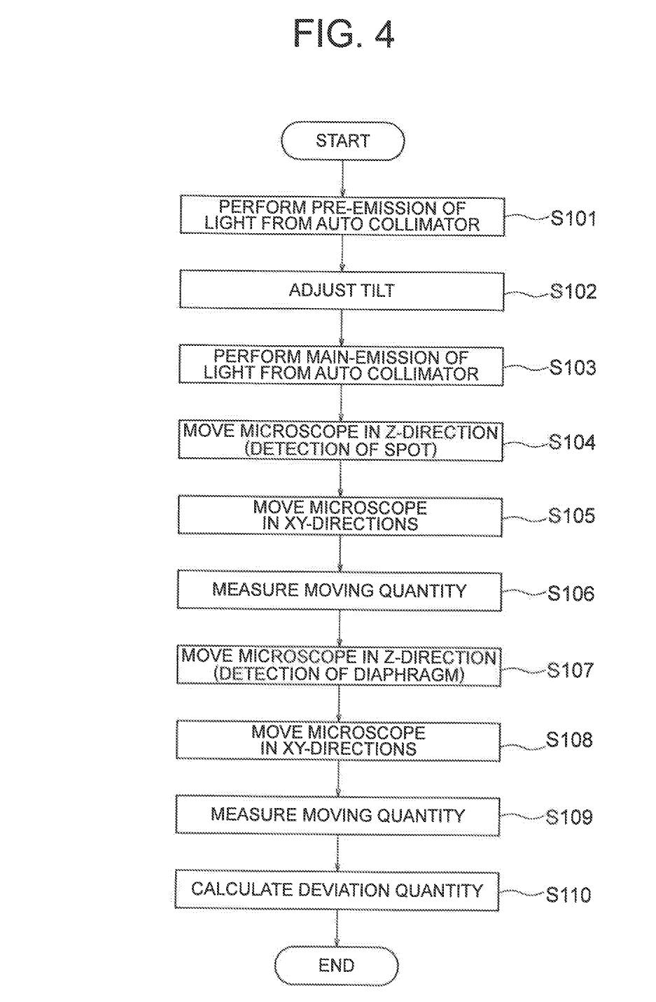

FIG. 4 is a flowchart illustrating an operation of the diaphragm position measuring apparatus. The operation of the diaphragm position measuring apparatus will be described with reference to FIG. 4. To start with, the measurement target lens unit LU is, as depicted in FIG. 3, to be placed in the way of directing the object side thereof toward the glass sheet GL.

Herein, the auto collimator AC is made to perform a pre-emission of the light beam in step S101. The pre-emitted light beam is reflected by the glass sheet GL on which the measurement target lens unit LU is placed and travels back to the auto collimator AC. A tilt adjustment is made while observing the light beam on the monitor MN in step S102, thus horizontalizing the glass sheet GL. In such a state, the optical axes of the lenses L1-LS4 of the lens unit LU are collimated with the laser beam L defined as a main light beam emitted from the auto collimator AC.

Further in step S103, the laser beam L defined as the collimated beam emitted from the auto collimator AC penetrates the glass sheet GL and enters the lenses LS1-LS4 of the lens unit LU via the optical diaphragm S. Then, the laser beam L forms the light condensing spot in an upper predetermined position. An image of the light condensing spot such as this is observed by the microscope MS via the ND filter ND. More specifically, in step S104, the microscope MS is moved in the Z-direction, thereby adjusting a diameter of the light condensing spot to 20 μm or under. Note that a circularity of the spot decreases as the light condensing spot becomes small, and it is preferable that the measurement accuracy consequently rises. A result of the experimental demonstrates that the circularity of the spot is at a level equal to or smaller than 3% against the diameter (the circularity is equal to or smaller than 0.6 μm against 20 μm of the light condensing spot).

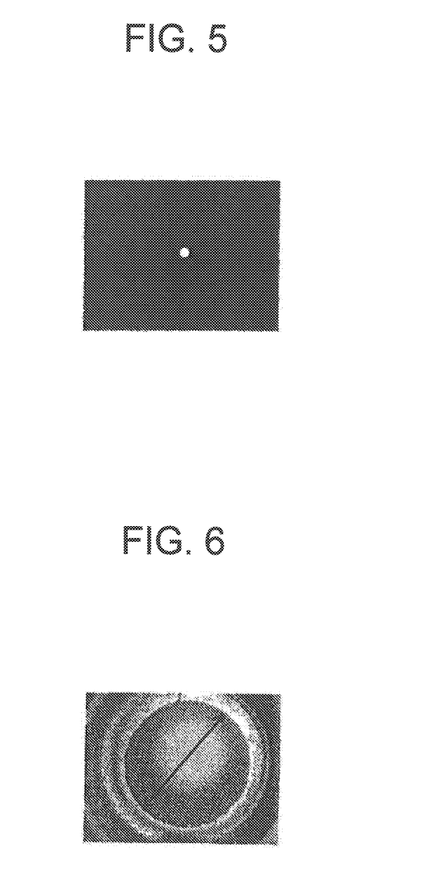

At this time, the image of the light condensing spot penetrates the optical system OS of the microscope MS and is formed on a light receiving surface of the imaging element CCD, and hence the formed image is displayed on the monitor MT (see FIG. 5). Further, in step S105, the image of the light condensing spot is made coincident with a reference position (e.g., the center) of the monitor MT by moving the microscope MS in the X- and Y-directions. Then, in step S106, the central processing unit CONT obtains X-Y coordinates of the light condensing spot from the moving quantities.

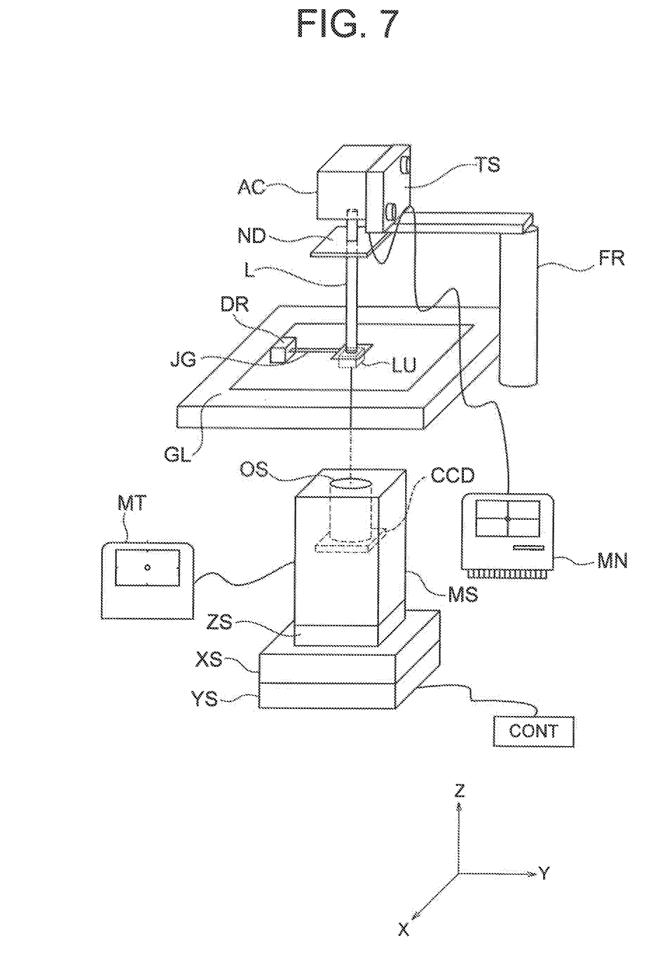

Subsequently, the auto collimator AC stops emitting the laser beam L, and the microscope MS is adjusted in such a position as to focus on the optical diaphragm S by moving the microscope MS in the Z-direction in step S107. At this time, an image of the optical diaphragm S illuminated with illumination light and indoor light penetrates the optical system OS of the microscope MS and is formed on the light receiving surface of the imaging element COD, and therefore the thus-formed image is displayed on the monitor MT (see FIG. 6). A central position of the image of the optical diaphragm S is known from an inside diameter thereof, and hence the center of the image of the optical diaphragm S is made coincident (e.g., concentric) with the reference position of the monitor MT by moving the microscope MS in the X- and Y-directions in step S108. Then, in step S109, the central processing unit CONT obtains X-Y coordinates of the center of the optical diaphragm S from the moving quantities of the microscope MS.

Moreover, in step S110, the central processing unit CONT calculates a quantity of deviation from the obtained X-Y coordinates of the light condensing spot and the obtained X-Y coordinates of the center of the optical diaphragm S. The operation of the diaphragm position measuring apparatus is finished so far.

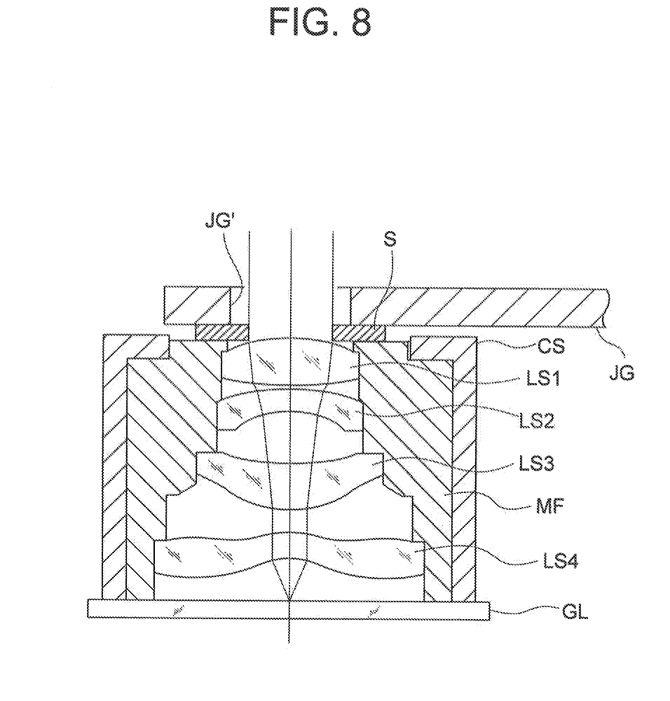

FIG. 7 is a schematic perspective view of the diaphragm position measuring apparatus according to the embodiment. The diaphragm position measuring apparatus builds up a part of an apparatus for manufacturing the lens unit LU. In FIG. 7, the perpendicular direction is defined by the Z-direction, while the horizontal direction is defined by the X- and Y-directions. The auto collimator AC and the tilt stage TS, which serve as tilt detecting means, are installed on the frame FR. The tilt stage TS is constructed to enable the auto collimator AC to be tilted with respect to the frame FR. The measurement target lens unit. LU (with the optical diaphragm S not being fixed) is placed on the glass sheet. GL fixed to the frame FR in the way of directing the object side thereof toward the auto collimator AC (see FIG. 8). Note that the auto collimator AC is configured to emit the laser beam L defined as the collimated beam in the downward direction, detect a reflected image and project this image on the monitor MN. The aperture (the stop for the measurement) is provided between the auto collimator AC and the glass sheet GL, thereby enabling unnecessary light beams to be cut and improving the measurement accuracy as the case may be.

The ND filter ND serving as the light reduction member is disposed between the auto collimator AC and the lens unit LU, and the microscope MS is disposed under the glass sheet GL. The glass sheet GL may also serve as the ND filter ND. The microscope MS is movable in the Z-direction by the Z-directional stage ZS, movable in the X-direction by the X-directional stage XS and movable in the Y-direction by the Y-directional state YS. Note that the respective stages are provided with the unillustrated drive sources and the sensors (the moving quantity detecting means) which detect the moving quantities, i.e., the Z-directional moving quantity, the X-directional moving quantity and the Y-directional moving quantity, and these moving quantities are inputted to the central processing unit CONT.

The microscope MS includes the optical system OS and the imaging element COD, in which the imaging element GOD captures the image of the light penetrating the optical system OS, and the image is projected on the monitor MT.

Herein, in this lens unit LU, as depicted in FIG. 8, the lenses LS1-LS4 are fixed to the mirror frame MF, however, the optical diaphragm S is not fixed to the mirror frame MF but is to be in a state of being held by a jig JG. This holding state is referred to as a temporary holding state. The jig JG serving as a holding member includes an aperture JG1 having such a dimension as not to intercept the laser beam L incident upon the optical diaphragm S, and is configured to enable the optical diaphragm S to be held on the undersurface thereof by dint of, e.g., vacuum absorption or electrostatic absorption. Further, as illustrated in FIG. 7, the jig JG is movable in the X- and Y-directions by a driving device DR.

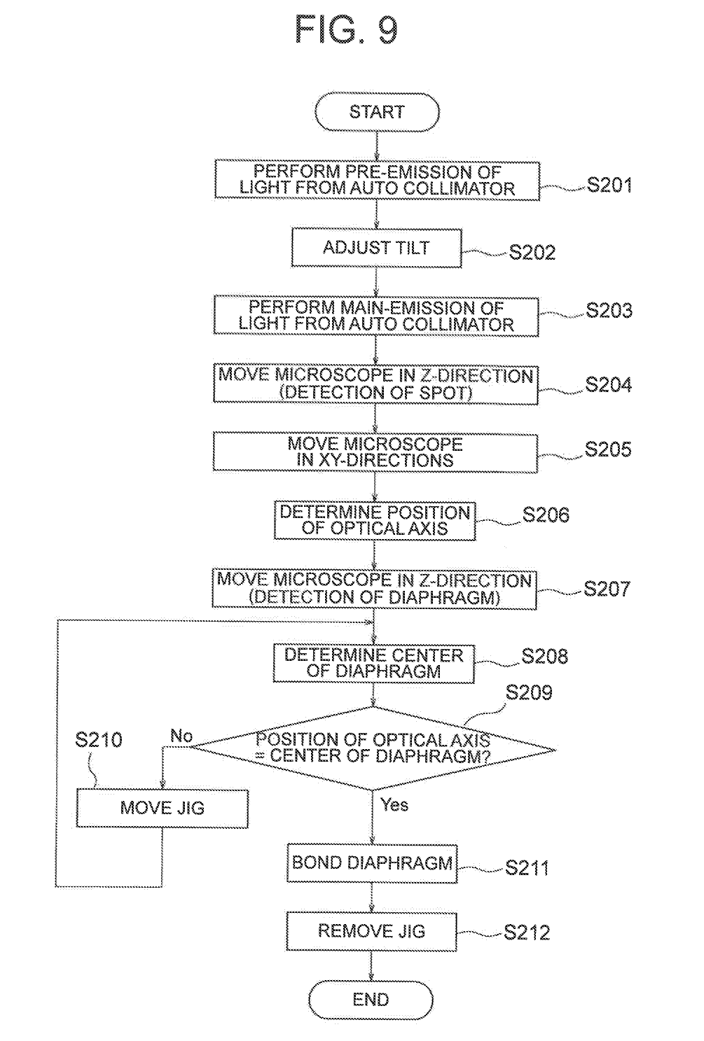

FIG. 9 is a flowchart illustrating the operation of the diaphragm position measuring apparatus. The operation of the diaphragm position measuring apparatus will be described with reference to FIG. 9. The auto collimator AC is made to perform the pre-emission of the light beam in step S201. The pre-emitted light beam is reflected by the glass sheet GL (or may be reflected by a flange etc orthogonal to the optical axis of the lens LS4) on which the measurement target lens unit LU is placed and travels back to the auto collimator AC. The tilt adjustment is made while observing the light beam on the monitor MN in step S202, thus setting the auto collimator AC just in a face-to-face relation with the glass sheet. GL. In such a state, the optical axes of the lenses LS1-LS4 of the lens unit LU are coaxial with the laser beam L defined as the main light beam emitted from the auto collimator AC. Note that this operation is sufficient if performed at the beginning in the case of assembling the optical diaphragms S to the plurality of lens units LU.

Further in step S203, the laser beam L defined as the collimated beam is emitted from the auto collimator AC and is made incident on the lenses LS1-LS4 of the lens unit LU via the ND filter ND and the optical diaphragm S held by the jig JG. Then, the laser beam L forms the light condensing spot on the glass sheet GL. An image of the light, condensing spot is observed through the microscope MS under the glass sheet CL. More specifically, in step S204, the microscope MS is adjusted in such a position that a focal position of the optical system OS is focused on the light condensing spot on the glass sheet GL by moving the microscope MS in the Z-direction.

At this time, the image of the light condensing spot penetrates the optical system OS of the microscope MS and is formed on the light receiving surface of the imaging element COD, and hence this formed image is displayed on the monitor MT (see FIG. 5). Furthermore, in step S105, the image of the light condensing spot is set coincident with the reference position (e.g., the center) of the monitor MT by moving the microscope MS in the X- and Y-directions. Then, in step S206, the central processing unit CONT determines this position to be an optical-axis position.

Subsequently, the auto collimator AC stops emitting the laser beam L, and the microscope MS is adjusted in the position that focuses on the optical diaphragm S by ascending the microscope MS in the Z-direction in step S207. At this time, the image of the optical diaphragm S illuminated with the illumination light and the indoor light penetrates the optical system OS of the microscope MS and is formed on the light receiving surface of the imaging element CCD, and therefore the thus-formed image is displayed on the monitor MT (see FIG. 6). The central position of the image of the optical diaphragm S is known from the inside diameter thereof, and hence the central processing unit CONT obtains the center of the image of the optical diaphragm S in step S208 and determines in step S209 whether or not the center deviates from the reference position (i.e., the optical axis) of the monitor MT.

The central processing unit CONT, if determining that the center of the image of the optical diaphragm S deviates from the reference position of the monitor MT, moves the optical diaphragm S together with the jig JG in the X- or Y-direction in step S210, then obtains the center of the image of the optical diaphragm S in step S208, and determines in step S209 whether the center deviates from the reference position (i.e., the optical axis) of the monitor MT or not. This operation is iterated till the both become coincident with each other.

The central processing unit CONT, whereas if determining that the center of the image of the optical diaphragm S is coincident with the reference position of the monitor MT, fixes the optical diaphragm S to the mirror frame MF by discharging an unillustrated UV curable adhesive from a gap of the jig JG in step S211. Thereafter, in step S212, the jig JG opens the optical diaphragm S. The operation of the diaphragm position measuring apparatus is finished so far.

A working example carried out by the present inventors will hereinafter be described. What was done by the present inventors is that lens units A, B, into which the optical diaphragms S are assembled, are prepared; the central position of the optical diaphragm S is measured beforehand by use of the microscope including the X-Y stage with respect to each of the lens units; a spot image forming position is measured by the microscope; a calculated value of the deviation from the central position of the optical diaphragm is set as a measurement result 1 (the working example); an imaginary optical axis position calculated from an outside diameter of the mirror frame of the lens and a calculated value of the deviation from the central position of the optical diaphragm are set as a measurement result 2 (a comparative example); and a value of the deviation from the central position of the optical diaphragm is set as a measurement result 3, the value being calculated by putting a molding transfer mark on the center of the optical surface (on the optical axis of the lens) of the image-sided lens building up the lens unit and measuring the physically specified position of the optical axis by the microscope. A comparison of the deviation quantity is made based on a scalar quantity √(x²+y²). Note that with reference to FIG. 1, let XA be the center of the optical diaphragm and XB be the imaginary optical axis calculated from the outside diameter of the mirror frame, however, XA and XB are shifted to facilitate the understanding. Herein, a true optical-axis position is unknown, and hence the deviation quantity of the measurement result 3 is set temporarily as the true value (reference) and is compared with the measurement results 1, 2. Table 1 shows the measurement results 1-3

TABLE 1
Table: Deviation Quantity of Center of Optical
diaphragm from Center of Lens Unit

| | | Measurement | Measurement | Measurement |
|---|---|---|---|---|
| | | Result 1 | Result 2 | Result 3 |
| Lens | X-Direction | −00060 | −0.0152 | −0.0042 |
| Unit | Y-Direction | 0.0016 | −0.0131 | 0.0030 |
| A | Deviation | 0.0023 | 0.0149 | — |
| | Quantity | | | |
| | from | | | |
| | Measurement | | | |
| | Result 3 | | | |
| Lens | X-Direction | 0.0043 | 0.0102 | 0.0062 |
| Unit | Y-DirectIon | 0.0063 | −0.0155 | 0.0048 |
| B | Deviation | 0.0024 | 0.0207 | — |
| | Quantity | | | |
| | from | | | |
| | Measurement | | | |
| | Result 3 | | | |

Unit: mm

According to Table 1, with respect to the lens unit A, an error of 14.9 μm occurs in the measurement result 2 given by way of the comparative example against the measurement result 3 given as the reference, however, the error was within 2.3 μm in the measurement result 1 by way of the working example. On the other hand, with respect to the lens unit B, an error of 20.7 μm occurs in the measurement result 2 given by way of the comparative example against the measurement result 3 given as the reference, however, the error was within 2.4 μm in the measurement result 1 given by way of the working example. The effects of the present invention were thereby confirmed.

It is apparent to those skilled in the art, it should be noted, from the embodiment described in the present specification and from the technical ideas that the present invention is limited to neither the embodiment nor the working example described in the present specification but embrace other embodiments and other modified examples.

### TECHNICAL APPLICABILITY

According to the diaphragm position measuring method and the diaphragm position measuring apparatus of the present invention, it is feasible to measure the deviation quantity between the center of the optical diaphragm and the optical axis with high accuracy. Further, according to the diaphragm position measuring method and the diaphragm position measuring apparatus of the present invention, the optical diaphragm can be disposed with the high accuracy. It is therefore possible to realize the highly accurate imaging apparatus using, e.g., the solid-state imaging device.

### DESCRIPTION OF THE REFERENCE NUMERALS AND SYMBOLS

AC auto collimator
COD imaging element
CONT central processing unit
CS case
DR driving device
FR frame
surface plate
GL glass sheet
JG jig
JG1 aperture
L laser beam
LS1-LS4 lens
LU lens unit
MF mirror frame
MN monitor
MS microscope
MT monitor
ND ND filter
OS optical system
predetermined position
S optical diaphragm
TS tilt stage
XS X-directional stage
YS Y-directional stage
ZS Z-directional stage

What is claimed is:

1. A diaphragm position measuring method of measuring a position of an optical diaphragm in a lens unit including the optical diaphragm, lenses and a mirror frame holding the optical diaphragm and the lenses, the method comprising:
a step of forming a light condensing spot by getting a collimated beam of light parallel with an optical axis of the lenses incident upon the lenses of the lens unit;
a step of detecting a position of the light condensing spot;
a step of detecting a central position of the optical diaphragm; and
a step of obtaining a deviation quantity between the position of the light condensing spot and the central position of the optical diaphragm.

2. The diaphragm position measuring method according to claim 1, wherein the step of detecting the central position of the optical diaphragm involves obtaining geometrically the central position of the optical diaphragm from a shape of an inside diameter of the optical diaphragm.

3. A diaphragm position measuring apparatus of measuring a position of an optical diaphragm in a lens unit including the optical diaphragm, lenses and a mirror frame holding the optical diaphragm and the lenses, the apparatus comprising:
a support base including at least a portion as a transmitted portion that can be penetrated by the light and supporting the lens unit in superposition on the transmitted portion;
a light irradiation device irradiating the lens unit with the collimated beam of light parallel with the optical axis of the lenses of the lens unit;
first detecting means detecting a position of the light condensing spot formed when the collimated beam of light penetrates the lenses of the lens unit;
second detecting means detecting the central position of the optical diaphragm; and
arithmetic means obtaining a deviation quantity between the detected position of the light condensing spot and the central position of the optical diaphragm.

4. The diaphragm position measuring apparatus according to claim 3, further comprising a Z-directional moving stage moving the first detecting means and/or the second detecting means and the support base relatively in a collimated beam emitting direction.

5. The diaphragm position measuring apparatus according to claim 3 or 4, further comprising:
an XY-directional moving stage moving the first detecting means and/or the second detecting means and the support base relatively in a direction orthogonal to the collimated beam emitting direction; and
moving quantity detecting means detecting a moving quantity of the XY-directional moving stage.

6. The diaphragm position measuring apparatus according to any one of claims 3 to 5, further comprising a tilt stage tilting the light irradiation device and the support base relatively in the collimated beam emitting direction.

7. The diaphragm position measuring apparatus according to claim 6, further comprising tilt detecting means detecting a relative tilt of the support base to the collimated beam of light.

8. The diaphragm position measuring apparatus according to any one of claims 3 to 7, wherein a light reduction member is inserted in between the first detecting means and the support base.

9. The diaphragm position measuring apparatus according to any one of claims 3 to 8, wherein the first detecting means serves also as the second detecting means.

10. An optical diaphragm positioning method of positioning an optical diaphragm with respect to a lens unit including lenses and a mirror frame holding the lenses, the method comprising:
a step of forming a light condensing spot by getting a collimated beam of light parallel with an optical axis of the lenses incident upon the lenses of the lens unit;
a step of holding the optical diaphragm in the lens unit in a way that temporarily positions the optical diaphragm;
a step of detecting a central position of the optical diaphragm;
a step of shifting the optical diaphragm so that the central position of the optical diaphragm is coincident with the position of the light condensing spot; and
a step of fixing the optical diaphragm to the lens unit when the central position of the optical diaphragm becomes coincident with the position of the light condensing spot.

11. The optical diaphragm positioning method according to claim 10, wherein the step of detecting the central position of the optical diaphragm involves obtaining geometrically the central position of the optical diaphragm from a shape of an inside diameter of the optical diaphragm.

12. An optical diaphragm positioning apparatus for positioning an optical diaphragm with respect to a lens unit including lenses and a mirror frame holding the lenses, the apparatus comprising:
a support base including at least a portion composed of a material that can be penetrated by the light and supporting the lens unit;
a holding member holding the optical diaphragm in the lens unit in a way that temporarily positions the optical diaphragm;
a light irradiation device irradiating the lens unit with a collimated beam of light parallel with an optical axis of the lenses of the lens unit;
first detecting means detecting a position of the light condensing spot formed when the collimated beam of light penetrates the lenses of the lens unit;
second detecting means detecting a central position of the optical diaphragm; and
a driving device shifting the holding member together with the optical diaphragm so as to decrease a deviation quantity between the detected position of the light condensing spot and the central position of the optical diaphragm.

13. The optical diaphragm positioning apparatus according to claim 12, further comprising a Z-directional moving stage moving the first detecting means or the second detecting means and the support base relatively in a collimated beam emitting direction.

14. The optical diaphragm positioning apparatus according to claim 12 or 13, further comprising:
an XY-directional moving stage moving the first detecting means or the second detecting means and the support base relatively in a direction orthogonal to the collimated beam emitting direction; and
moving quantity detecting means detecting a moving quantity of the XY-directional moving stage.

15. The optical diaphragm positioning apparatus according to any one of claims 12 to 14, further comprising a tilt stage tilting the light source and the support base relatively in the collimated beam emitting direction.

16. The optical diaphragm positioning apparatus according to claim 15, further comprising tilt detecting means detecting a relative tilt of the support base to the collimated beam of light.

17. The optical diaphragm positioning apparatus according to any one of claims 12 to 16, wherein a light reduction member is inserted in between the first detecting means and the support base.

18. The optical diaphragm positioning apparatus according to any one of claims 12 to 17, wherein the first detecting means serves also as the second detecting means.
